(19) United States
(12) Patent Application Publication
(10) Pub. No.: US 2026/0239473 A1
(43) Pub. Date: Aug. 13, 2026

(54) INFORMATION PROCESSING METHOD AND APPARATUS, COMMUNICATION DEVICE, AND STORAGE MEDIUM

(71) Applicant: Beijing Xiaomi Mobile Software Co., Ltd., Beijing (CN)

(72) Inventors: Yanhua LI, Beijing (CN); Yumin WU, Beijing (CN); Xiaowei JIANG, Beijing (CN)

(73) Assignee: Beijing Xiaomi Mobile Software Co., Ltd., Beijing (CN)

(21) Appl. No.: 19/155,804

(22) PCT Filed: Feb. 17, 2023
(86) PCT No.: PCT/CN2023/076817

§ 371 Date: Aug. 12, 2025

(51) Int. Cl. H04W 76/20; H04W 28/02; H04W 80/02

(52) U.S. Cl. CPC H04W 76/20; H04W 28/0252; H04W 28/0273; H04W 80/02

(57) ABSTRACT

Embodiments of the present disclosure provide an information processing method and apparatus, a communication device, and a storage medium. The information processing method performed by a sending end may comprise: according to first attribute information of target data to be sent, determining a radio link control (RLC) entity for sending the target data.

### CROSS-REFERENCE TO RELATED APPLICATIONS

The present application is a U.S. National Phase application of International Application No. PCT/CN2023/076817, filed on Feb. 17, 2023, the entire contents are incorporated herein by reference.

### TECHNICAL FIELD

The present disclosure relates to the field of wireless communication technology but is not limited to the field of wireless communication technology, and in particular to an information processing method and apparatus, a communication device and a storage medium.

### BACKGROUND

The access device or user equipment (UE) is configured with the Packet Data Convergence Protocol (PDCP) layer, the Radio Link Control (RLC) layer, the Media Access Control (MAC) layer, and the Physical (PHY) layer. The RLC layer is located between the PDCP layer and the MAC layer. The MAC layer is located between the RLC layer and the PHY layer.

In case that data is sent, the PDCP layer forms a PDCP protocol data unit (PDU) to be transmitted; the RLC layer can be used to packaging the PDCP data unit into a service data unit (SDU); the MAC layer can be used to process the SDU of the RLC layer into a MAC PDU, and provide the MAC PDU to the PHY layer to convert it into a transmission block (TB) for transmission.

In case that data is received, the PHY layer receives the TB and submits the received TB to the MAC layer. The MAC layer converts the TB into a MAC PDU and provides it to the RLC layer, while the RLC layer assembles the MAC PDU into an SDU and submits it to the PDCP layer. The PDCP layer converts the SDU into a PDCP data unit and performs subsequent processing on the PDCP PDU.

It should be noted that, information disclosed in the above background portion is provided only for better understanding of the background of the present disclosure, and thus it may contain information that does not form the prior art known by those ordinary skilled in the art.

### SUMMARY

Embodiments of the present disclosure provide an information processing method and apparatus, a communication device, and a storage medium.

A first aspect of an embodiment of the present disclosure provides an information processing method, which is executed by a transmitter, and the method includes:
determining a radio link control (RLC) entity for sending target data based on first attribute information of the target data to be sent.

A second aspect of an embodiment of the present disclosure provides an information processing method, which is executed by an access device, and the method includes:
sending first configuration information to a user equipment (UE), wherein the first configuration information includes:
identification information, indicating an RLC entity for sending target data; and
second attribute information, indicating an attribute of data that can be transmitted by the RLC entity for sending the target data.

A third aspect of the embodiments of the present disclosure provides an information processing method, which is executed by a user equipment (UE), and the method includes:
receiving first configuration information sent by an access device; wherein the first configuration information includes:
identification information, indicating an RLC entity for sending target data; and
second attribute information, indicating an attribute of data that can be transmitted by the RLC entity for sending the target data.

A fourth aspect of the embodiments of the present disclosure provides an information processing apparatus, wherein the apparatus includes:
a determining module, configured to determine a radio link control (RLC) entity for sending target data based on first attribute information of the target data to be sent.

A fifth aspect of the embodiments of the present disclosure provides an information processing apparatus, wherein the apparatus includes:
a sending module, configured to send first configuration information to a user equipment (UE), wherein the first configuration information includes:
identification information, indicating an RLC entity for sending target data; and
second attribute information, indicating an attribute of data that can be transmitted by the RLC entity for sending the target data.

A sixth aspect of the embodiments of the present disclosure provides an information processing apparatus, wherein the apparatus includes:
a receiving module, configured to receive first configuration information sent by an access device; wherein the first configuration information includes:
identification information, indicating an RLC entity for sending target data; and
second attribute information, indicating an attribute of data that can be transmitted by the RLC entity for sending the target data.

A seventh aspect of an embodiment of the present disclosure provides a communication device, including a processor, a transceiver, a memory, and an executable program stored in the memory and capable of being run by the processor, wherein when the processor runs the executable program, the processor executes the information processing method provided in any one of the technical aspects of the first to third aspects above.

An eighth aspect of an embodiment of the present disclosure provides a computer storage medium storing an executable program; after the executable program is executed by a processor, the processor executes the information processing method provided in any one of the technical aspects of the first to third aspects above.

It is to be understood that both the foregoing general description and the following detailed description are exemplary and explanatory only and are not restrictive of the embodiment of the present disclosure.

### BRIEF DESCRIPTION OF THE DRAWINGS

The accompanying drawings herein are incorporated in and constitute a part of the specification, illustrate embodiments consistent with the present disclosure, and together with the description, serve to explain the principles of the embodiments of the present disclosure.

FIG. 1 is a schematic structural diagram of a wireless communication system according to an exemplary embodiment;

FIG. 2A is a schematic flow chart of an information processing method according to an exemplary embodiment;

FIG. 2B is a schematic flow chart of an information processing method according to an exemplary embodiment;

FIG. 2C is a schematic flow chart of an information processing method according to an exemplary embodiment;

FIG. 2D is a schematic flow chart of an information processing method according to an exemplary embodiment;

FIG. 2E is a schematic flow chart of an information processing method according to an exemplary embodiment;

FIG. 2F is a schematic flow chart of an information processing method according to an exemplary embodiment;

FIG. 2G is a schematic flow chart of an information processing method according to an exemplary embodiment;

FIG. 2H is a schematic flow chart of an information processing method according to an exemplary embodiment;

FIG. 3A is a schematic flow chart of an information processing method according to an exemplary embodiment;

FIG. 3B is a schematic flow chart of an information processing method according to an exemplary embodiment;

FIG. 3C is a schematic flow chart of an information processing method according to an exemplary embodiment;

FIG. 4A is a schematic flow chart of an information processing method according to an exemplary embodiment;

FIG. 4B is a schematic flow chart of an information processing method according to an exemplary embodiment;

FIG. 4C is a schematic flow chart of an information processing method according to an exemplary embodiment;

FIG. 5 is a schematic diagram showing the structure of an information processing apparatus according to an exemplary embodiment;

FIG. 6 is a schematic diagram showing the structure of an information processing apparatus according to an exemplary embodiment;

FIG. 7 is a schematic diagram showing the structure of an information processing apparatus according to an exemplary embodiment;

FIG. 8 is a schematic diagram showing the structure of a UE according to an exemplary embodiment;

FIG. 9 is a schematic diagram showing the structure of a network device according to an exemplary embodiment.

### DETAILED DESCRIPTION

Exemplary embodiments are described in detail herein, examples of which are shown in the accompanying drawings. When the following description refers to the drawings, unless otherwise indicated, the same numbers in different drawings represent the same or similar elements. The embodiments described in the following exemplary embodiments do not represent all embodiments consistent with the embodiments of the present disclosure. Instead, they are merely examples of devices and methods consistent with some aspects of the embodiments of the present disclosure.

The terms used in the embodiments of the present disclosure are only for the purpose of describing specific embodiments, and are not intended to limit the embodiments of the present disclosure. The singular forms of one, and the, used in the present disclosure are also intended to include the plural forms, unless the context clearly indicates other meanings. It should also be understood that the terms and/or used in this article refer to and include any or all possible combinations of one or more associated listed items.

It should be understood that, although the terms first, second, third, etc. may be used to describe various information in the disclosed embodiments, the information should not be limited to these terms. These terms are only used to distinguish the same type of information from each other. For example, without departing from the scope of the disclosed embodiments, the first information may also be referred to as the second information, and similarly, the second information may also be referred to as the first information. Depending on the context, the word if as used herein may be interpreted as when or in the case of or in response to determination.

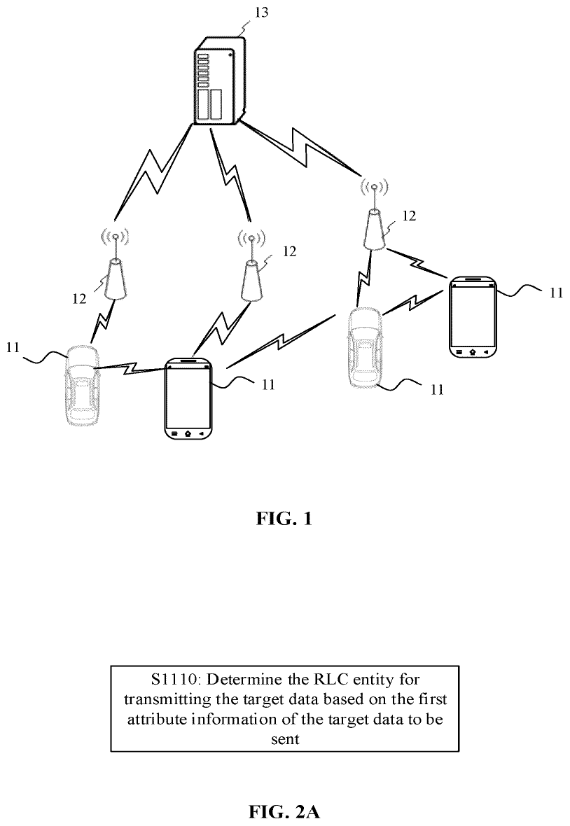

Referring to FIG. 1, which shows a schematic diagram of the structure of a wireless communication system provided by an embodiment of the present disclosure. As shown in FIG. 1, the wireless communication system is a communication system based on cellular mobile communication technology, and the wireless communication system may include: a plurality of UEs 11 and a plurality of access devices 12. In some embodiments, the communication system may also include: one or more core network devices, which are not shown in FIG. 1. The core network device includes, but is not limited to: a mobile management entity (MME) or an access management function (AMF), etc.

The UE 11 can be a device that provides voice and/or data connectivity to users. The UE 11 can communicate with one or more core networks via a radio access network (RAN). The UE 11 can be an Internet of Things UE, such as a sensor device, a mobile phone (or a cellular phone) and a computer having an Internet of Things UE, for example, it can be a fixed, portable, pocket-sized, handheld, computer-built-in or vehicle-mounted device. For example, a station (STA), a subscriber unit, a subscriber station, a mobile station, a mobile, a remote station, an access point, a remote terminal, an access terminal, a user terminal, a user agent, a user device, or a user equipment (UE). Alternatively, the UE 11 can also be a device of an unmanned aerial vehicle. Alternatively, the UE 11 can also be a vehicle-mounted device, for example, it can be a driving computer with wireless communication function, or a wireless communication device connected to a driving computer. Alternatively, the UE 11 may also be a roadside device, for example, a street lamp, a signal lamp or other roadside device with a wireless communication function.

The access device 12 may be a network side device in a wireless communication system. The wireless communication system may be a fourth generation mobile communication technology (4G) system, also known as a long term evolution (LTE) system; or, the wireless communication system may be a 5G system, also known as a new radio (NR) system or a 5G NR system. Alternatively, the wireless communication system may be a next generation system of the 5G system. The access network in the 5G system may be called NG-RAN (New Generation-Radio Access Network). Alternatively, an MTC system.

The access device 12 can be an evolved base station (eNB) adopted in a 4G system. Alternatively, the access device 12 can also be a base station (gNB) adopting a centralized distributed architecture in a 5G system. When the access device 12 adopts a centralized distributed architecture, it usually includes a central unit (CU) and at least two distributed units (DU). The centralized unit is provided with a packet data convergence protocol (PDCP) layer, a radio link layer control protocol (Radio Link Control, RLC) layer, and a media access control (MAC) layer protocol stack; the distributed unit is provided with a physical (PHY) layer protocol stack. The embodiment of the present disclosure does not limit the specific implementation method of the access device 12.

A wireless connection may be established between the access device 12 and the UE 11 via a wireless air interface. In different implementations, the wireless air interface is a wireless air interface based on the fourth generation mobile communication network technology (4G) standard; or, the wireless air interface is a wireless air interface based on the fifth generation mobile communication network technology (5G) standard, for example, the wireless air interface is a new air interface; or, the wireless air interface may also be a wireless air interface based on the next generation mobile communication network technology standard of 5G.

In the related art, one PDCP entity in the PDCP layer may be associated with one or more RLC entities in the RLC layer.

The PDCP entity may have a traffic splitting function. When implementing the traffic splitting function, PDCP can deliver different PDUs to different RLC entities to distribute data. For example, there are primary RLC entities and secondary RLC entities among multiple RLC entities. For example, the PDU carrying control data is delivered to the primary RLC entity. The PDU of service data can be delivered to the primary RLC entity, and part of it is delivered to the secondary RLC entity. Specifically, when the total data volume of one or more PDUs of service data is small, the PDCP entity can deliver more PDUs to the primary RLC entity for processing, and when the total data volume of one or more PDUs of service data is large, the PDCP entity can deliver part of the PDUs to the primary RLC entity and part of them to the RLC entity, and deliver them by the primary RLC entity and the secondary RLC entity at the same time.

The PDCP layer also has a duplication function. For example, to ensure the reliability of data transmission, each PDU is replicated one or more times and delivered to different RLC entities for subsequent processing.

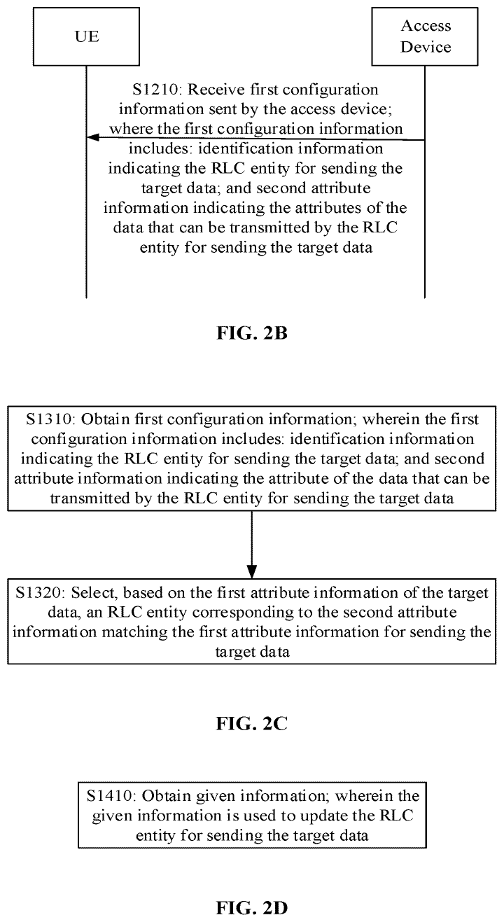

As shown in FIG. 2A, an embodiment of the present disclosure provides an information processing method, which is executed by a transmitter and includes:

S1110: Determine the RLC entity for transmitting the target data based on the first attribute information of the target data to be sent.

The execution subject of the information processing method may be: a target data transmitter. Exemplarily, the target data transmitter may be an access device shown in FIG. 1 or a UE shown in FIG. 1. The access device shown in FIG. 1 may include various types of base stations, for example, an eNB and/or a gNB.

Exemplarily, the UE may be any terminal with mobile communication capability. The UE may be a mobile terminal and/or a fixed terminal. The terminal may be, but is not limited to, a mobile phone, a wearable device, a vehicle terminal, a road side unit (RSU), a smart home terminal, a smart office device, an industrial sensor device and/or a medical device, etc.

The execution subject of the information processing method may be the PDCP entity of the UE.

Exemplarily, the target data may be one or more PDCP data units formed by a PDCP entity of a PDCP layer. The PDCP data units may carry control data and/or service data. These PDCP data units are carried on a radio bearer.

The PDCP data unit may include a PDCP PDU and/or a PDCP SDU. In some cases, the PDCP data unit processed by the PDCP entity may be a PDCP PDU and/or a PDCP SDU received by the PDCP layer.

Each PDCP PDU may include a header and a payload. The header may carry first attribute information. The payload may include control data and/or service data.

The first attribute information may be any data attribute indicating the importance of the payload portion of the PDU.

Exemplarily, the first attribute information may be an importance level indicating the importance of the payload part data of the PDCP data unit, or a priority, etc. Of course, this is only an example of the first attribute information, and the specific implementation is not limited to this example.

Different types of RLC entities have different QoS guarantees. For example, different types of RLC entities have different transmission modes, some of which support error correction, some support duplicate detection, and some may only support transparent transmission.

For example, different types of RLC entities are mapped to different logical channels or logical channel groups. Different logical channels or different logical channel groups have different QoS guarantees.

In one embodiment, different types of RLC entities may correspond to a MAC entity of the MAC layer of the transmitter. It should be noted that the MAC entity may packaging data packets from different RLC entities into MAC PDUs or MAC sub-PDUs carrying logical channels or logical channel group IDs mapped by different RLC entities.

If the two PDU headers of the target data carry different importance levels, they may be delivered to different types of RLC entities for processing. Different types of RLC entities can provide different QoS guarantees for data transmission. Based on the first attribute information of different PDCP data units of the target data, the RLC entity that can provide the corresponding QoS guarantee is selected for data transmission, which is equivalent to selecting the RLC entity that matches the importance level of the PDU reflected by the first attribute information of each PDCP data unit for data transmission in the UE.

The data transmission of the RLC entity here may include assembling one or more PDCP data units with smaller data volume into an SDU, or splitting a PDU with larger data volume into multiple SDUs, and performing RLC layer related processing such as transparent transmission, repackaging, duplicate detection and/or error correction on the data based on the transmission mode of the RLC entity.

In some embodiments, the target data may be control data or service data. When the target data is control data, one or more RLC entities capable of providing the QoS required by the first attribute information may be selected to transmit different parts of the control data based on different first attribute information of the control data.

In other embodiments, the target data may be service data. In this case, different parts of the target data may come from different QoS flows of the same service, or different QoS sub-flows of the same QoS flow; or data of different modalities of the same service.

Exemplarily, for the video data, I frames and P frames may be included. Usually, I frames can be encoded and decoded independently; while P frames need to rely on I frames or other P frames for joint decoding. It can be seen that in order to achieve successful transmission and reception of video data, I frames are obviously more important than P frames. In this way, the importance indicated by the first attribute information in the PDU header carrying the I frame may be higher than the importance indicated by the second attribute information in the PDU header carrying the P frame. At this time, the QoS requirement of the I frame is higher than the QoS requirement of the P frame.

Exemplarily, data for extended reality (XR) services may include: display data of display devices, voice data of voice devices and/or sensor data such as touch sensors, etc. Display data, voice data and sensor data belong to data of different modalities. XR services may include: augmented reality (AR) services, virtual reality (VR) services and/or mixed reality (MR) services. MR services may have the characteristics of both AR services and VR services. Usually, different parts of XR service data may have different QoS requirements. For example, biometric data collected by sensors in XR services can be used for user identity authentication and/or payment verification, and may have higher QoS requirements than voice data of voice devices.

Exemplarily, in some embodiments, the method may further include: determining whether the data to be transmitted is designated target data. Exemplarily, determining whether the data to be transmitted is service data of a designated service or service type, if so, the data to be transmitted is the target data. For the transmission of the target data, it is necessary to select a corresponding type of RLC entity to transmit the target data based on the first attribute information of the target data. The designated service includes but is not limited to the aforementioned XR service and/or video service.

In the embodiments of the present disclosure, the same or different RLC entities can be selected to transmit different parts of the target data based on the first attribute information of different parts in the target data. In this way, some data with high QoS requirements can be transmitted using an RLC entity with high QoS guarantee, while some data with low QoS requirements can be transmitted using an RLC entity with low QoS, thereby ensuring that the QoS requirements of different parts of the target data are better met and reducing congestion caused by data transmission using the same RLC entity.

In some embodiments, both of the UE and the access device, as transmitters, obtain first configuration information, and the first configuration information can be used for configuration of an RLC entity of the RLC layer of the transmitter, etc.

Exemplarily, the first configuration information is used by the transmitter to determine whether the RLC layer in the transmitter is configured with one or more RLC entities. If multiple RLC entities are configured, whether the first attribute information corresponding to each RLC entity is configured.

The SDUs formed by different types of RLC entities are mapped to different logical channels or different logical channel groups. In this way, after the MAC entity of the MAC layer receives the SDUs of different RLC entities, it generates a MAC PDU. A MAC PDU may include one or more MAC sub-PDUs. A MAC sub-PDU may include a subheader. The subheader may carry the logical channel identifier (LCID) or logical channel group identifier (LCG ID) mapped for the MAC sub-PDU. The SDUs of different types of RLC entities are packaged into different MAC sub-PDUs, to map to different LCs, and based on the QoS guarantee of the LC, the QoS guarantee of data transmission of different types of RLC entities is implemented.

In some embodiments, the first configuration information includes: identification information indicating the RLC entity for sending the target data; and second attribute information indicating the attributes of data that can be transmitted by the RLC entity for sending the target data.

Exemplarily, the first configuration information may be a list of RLC entities. The list may include identification information of the RLC entities, for example, the identification information may include the serial number of the RLC entity. At the same time, the list may also include second attribute information located in the same row as the identification information of each RLC entity.

Exemplarily, one piece of identification information may be used to identify an RLC entity established by the RLC layer of the UE. The RLC entity indicated by the identification information may be an established RLC entity and/or an RLC entity to be established.

The second attribute information may indicate any information characterizing its QoS requirements, such as the importance level and/or priority and/or service type of the data that the RLC entity intends to (or expects to) transmit. Exemplarily, the second attribute information may also be any information such as the importance level and/or priority and/or service type.

In another exemplary embodiment, the first configuration information may include one or more fields. One field may be used to configure an RLC entity of the RLC layer of the UE. For example, different parts of one field may carry identification information and second attribute information of the RLC entity to be established.

As another example, one RLC entity may be associated with multiple second attribute information. Different parts of the target data may have different second attributes. That is, one RLC entity may be used to transmit target data of multiple different attributes at the same time.

The first configuration information may be an RLC configuration for control data or service data. The RLC entity to be established may include one or more RLC entities, and different types of RLC entities may provide higher QoS guarantees. Exemplarily, the RLC entity may include: a primary RLC entity and a secondary RLC entity, and the primary RLC entity may provide higher QoS guarantees than the secondary QoS entity.

In addition, the first configuration information can also be used in combination with the protocol agreement. For example, two RLC entities are configured, namely the first RLC entity (or primary RLC entity) and the second RLC entity (or secondary RLC entity), which are used to transmit target data with importance level 1 and importance level 2 respectively. At the same time, according to the protocol agreement, the first RLC entity can also be used to carry control data generated by the PDCP layer itself, such as PDCP Control the PDU.

The first configuration information also includes:
Mode information, indicating a transmission mode of the RLC entity for transmitting target data.

The transmission modes include: Transparent Mode (TM), Unacknowledged Mode (UM) and/or Acknowledged Mode (AM).

The transparent transmission mode may be a transmission mode in which PDU is not converted into SDU, RLC header is not added, and data is not discarded, reordered, reassembled, or error corrected.

The unacknowledged mode may be a transmission mode in which the PDU is converted into an SDU, an RLC header is added to the SDU, and data is discarded, rearranged and/or reassembled.

The acknowledged mode may be a transmission mode in which the PDU is converted into an SDU, an RLC header is added to the SDU, and data is discarded, reordered, reassembled, and/or error corrected.

The transmission modes of different RLC entities may be different. For example, an RLC entity using AM may provide a higher QoS guarantee for data transmission than an RLC entity using UM. And an RLC entity using UM may provide a higher QoS guarantee for data transmission than an RLC entity using TM.

In some embodiments, the first attribute information includes one or more of the following;
importance level;
service type;
quality of service (QoS) flow identifier;
sub-QoS flow identifier; or
priority.

In some embodiments, the first attribute information may also include control data generated by the PDCP layer itself. The control data may also be referred to as control signaling.

The first attribute information may be obtained in several ways. One way is to obtain it from the header of the PDCP data unit. For example, the header of each PDCP data unit may carry its own first attribute information. For example, the header of the PDCP data unit may include an importance level.

Another way is to determine the first attribute information by the transmission address of the DCP data unit. For example, for downlink transmission, the access device associates different QoS flows with different transport layer addresses, and then the QoS flow identifier or sub-QoS flow identifier of the to which the PDCP data unit belongs is obtained based on the transport layer addresses.
Likewise,

The second attribute information includes the importance level, QoS flow ID or sub-QoS flow ID, etc., then the RLC entity with the second attribute information sends a PDCP data unit with the attributes defined by the second attribute information. The service type can be reflected by type identification information or service identification. The PDCP entity of the PDCP layer can send the PDCP data unit to the corresponding RLC entity based on the service type and/or service ID of the PDCP data unit to be sent to the RLC entity.

The QoS flow identifier may exemplarily include: a QoS flow identifier (QFI) of the fifth generation mobile communication (5G). Different QFIs map a set of different QoS parameters. The QoS parameters may include: transmission delay, transmission bandwidth, and/or parameters related to transmission error rate.

A QOS flow can be split into different sub-QoS flows, so that different sub-QoS flows can have different sub-QoS identifiers. Similarly, the sub-QoS identifier is mapped with one or more QoS parameters. Thus, similarly, the sub-QoS flow can also be used by the PDCP layer of the transmitter to determine the RLC entity to which the current PDCP data unit to be sent is sent.

The priority may be the service priority of the data and/or the priority of the logical channel for transmitting the data. The priority also reflects the importance of the data and/or the QoS requirement.

As shown in FIG. 2B, an embodiment of the present disclosure provides an information processing method, which is executed by a UE and includes:

S1210: Receive first configuration information sent by the access device; where the first configuration information includes: identification information indicating the RLC entity for sending the target data; and second attribute information indicating the attributes of the data that can be transmitted by the RLC entity for sending the target data.

The access device may be any access device as shown in FIG. 1, that is, the access device may be an eNB or a gNB.

Exemplarily, the first configuration information may be a list of RLC entities. The list may include identification information of the RLC entities, for example, the identification information may include the serial number of the RLC entity. At the same time, the list may also include second attribute information located in the same row as the identification information of each RLC entity.

Exemplarily, if the executor of the information processing method is a UE, the UE receives the first configuration information from the access device.

After receiving the second configuration information, the UE may establish a corresponding RLC entity before starting the transmission of the target data, thereby facilitating the subsequent transmission of the target data.

As shown in FIG. 2C, an embodiment of the present disclosure provides an information processing method, which is executed by a transmitter and includes:

S1310: Obtain first configuration information; where the first configuration information includes: identification information indicating the RLC entity for sending the target data; and second attribute information indicating the attribute of the data that can be transmitted by the RLC entity for sending the target data;

S1320: Select, based on the first attribute information of the target data, an RLC entity corresponding to the second attribute information matching the first attribute information for sending the target data.

In this way, by obtaining the first configuration information, the PDCP entity of the PDCP layer at the transmitter obtains the second attribute information of each RLC entity in the UE in advance, and then selects the RLC entity to receive each PDCP data unit based on the matching of the first attribute information and the second attribute information in the PDCP data unit assembled by itself. The first attribute information can be carried in the header of the PDCP data unit.

In some embodiments, the first configuration information may be semi-statically configured or dynamically configured. If it is semi-statically configured, for example, the configuration of the semi-static period of the RRC message is adopted. If it is dynamically configured, the activate/deactivate configuration or enable/disable configuration using the MAC CE may be adopted. Generally, the change frequency of semi-static configuration is lower than that of dynamic configuration.

As shown in FIG. 2D, an embodiment of the present disclosure provides an information processing method, which is executed by a transmitter and includes:

S1410: Obtain given information; wherein the given information is used to update the RLC entity for sending the target data.

The transmitter may also be a UE or an access device.

Exemplarily, the given information may be any information of the target data splitting configuration change, that is, the given information may be any data for the access device to update the RLC entity for sending the target data.

Exemplarily, the given information may include splitting configuration information.

The splitting configuration information may be used to reconfigure the target data transmission mode and/or update the RLC entity for transmission during the splitting transmission. For the target data, the reconfigured transmission mode may include splitting transmission and non-splitting transmission.

Exemplarily, the splitting configuration information can be used to indicate the switch of the target data transmission mode between splitting transmission and non-splitting transmission. If non-splitting transmission is used, all target data is sent by only one RLC entity. If splitting transmission is used, different parts of the target data are sent using different RLC entities due to the difference in their respective first attribute information. Therefore, it is obvious that the target data transmission mode being switched between splitting transmission and non-splitting transmission, is equivalent to updating the RLC entity for sending the target data.

As another example, the splitting configuration information may also be used to indicate the update of the sending RLC entity during the splitting transmission of the target data.

Exemplarily, the given information may be: reconstruction information, release information and/or deactivation information of an established RLC entity. The reconstruction information may indicate that the established RLC entity needs to be destroyed and reconstructed. During the destruction and reconstruction process, it is obvious that the RLC entity cannot be used to send target data, which is equivalent to updating the RLC entity for sending the target data. The release information may be used to release the RLC entity, and the released RLC entity is no longer reconstructed.

The state of the RLC entity may include: an activation state or an inactivation state of the RLC entity. The activation state may also be referred to as an activated state, and an RLC entity in an activated state may be referred to as an activated RLC entity. The inactivation state may also be referred to as an inactive state, a deactivated state, or a to-be-activated state. An RLC entity in an inactive state may be referred to as an inactive RLC entity, a to-be-activated RLC entity, or a deactivated RLC entity.

Exemplarily, the deactivation information is to change an RLC entity that is already in an activated state to a deactivated state. The RLC entity in the deactivated state suspends the transmission of target data, to achieve the update of the RLC entity for sending the target data.

As another example, the given information may be: establishment information, configuration information, or activation information of the RLC entity to be established.

The establishment information may be used to establish the RLC entity. For example, the first configuration information has completed the configuration of the RLC entity, but the establishment of the RLC entity has not been completed based on the first configuration information. The establishment of the RLC entity is implemented after receiving the establishment information.

The configuration information may be that the RLC entity for the target data to be transmitted has not been configured.

The activation information may be used for state switching of an established RLC entity from a deactivated state to an activated state.

The given information may be configured by an RRC message, a MAC layer message or downlink control information (DCI).

For example, the RLC entity currently transmitting the target data may include one or more second RLC entities. By obtaining the given information, the RLC entity of the target data may be updated to one or more second RLC entities.

In summary, in some embodiments, the access device can update the RLC entity for sending the target data based on changes in the QoS requirements of the target data and/or upgrades of the service data, so that the RLC entity for sending the target data can dynamically adapt to the QoS requirements required by different parts of the target data.

As shown in FIG. 2E, an embodiment of the present disclosure provides an information processing method, which is executed by a transmitter and includes:

S1510: Obtain second configuration information, where the second configuration information is used to reconfigure the RLC entity for sending target data.

For example, if the transmitter is a UE, the second configuration information may be received from an access device. If the transmitter is an access device, the second configuration information cached by the transmitter may be obtained and sent to the UE.

The second configuration information may be carried in any RRC message, MAC layer message and/or DCI sent by the access device.

Exemplarily, the second configuration information may be configured by an RRC reconfiguration message, an RRC reestablishment message, or an RRC recovery message.

Exemplarily, the second configuration information may be used to implement at least one of the following functions:

Disable or enable the splitting function of the target data; if the splitting function is enabled, at least two RLCs are used to send the target data;
Add the RLC entity for sending the target data;
Reduce the RLC entity for sending the target data;
Replace the RLC entity for sending the target data;
Update the second attribute information of the RLC entity for sending the target data;
Update the transmission mode of the RLC entity for sending the target data; and
Update the logical channel or logical channel group mapped by the RLC entity for sending the target data.

In some embodiments, the second configuration information may also include: a list of RLC entities. The list may include at least: identification information of the second RLC entity; and/or second attribute information corresponding to each second RLC entity, and/or mode information of the second RLC entity, and/or identification information of a logical channel or a logical channel group corresponding to the second RLC entity.

The second attribute information may indicate any information characterizing its QoS requirements, such as the importance level and/or priority level and/or service type of the data that the second RLC entity intends to (or expects to) transmit. Exemplarily, the second attribute information may also be any information such as the importance level and/or priority level and/or service type.

In another exemplary embodiment, the second configuration information may include one or more fields. One field may be used to configure an RLC entity of the RLC layer of the UE. For example, different parts of one field may carry identification information and second attribute information of the RLC entity to be established.

The second configuration information further includes: mode information indicating a transmission mode of the second RLC entity. The transmission mode of the second RLC entity may be AM, UM or TM.

As shown in FIG. 2F, an embodiment of the present disclosure provides an information processing method, which is executed by a transmitter and includes:

S1610: Obtain activation information, where the activation information is used to update the RLC entity for sending target data by activating an inactivated RLC entity and/or deactivating an activated RLC entity.

In this implementation scenario, the first configuration information configures the RLC entity, but the RLC entity may not be activated or may have been activated. The subsequent access device may instruct the UE or itself to switch the status of each RLC entity in the RLC layer through the activation information. The status of the RLC entity here may include: the activation state or the inactivation state of the RLC entity. The activated state may also be referred to as the activated state, and the RLC entity in the activated state may be referred to as the activated RLC entity. The inactivation state may also be referred to as the inactivated state or the deactivated state or the to-be-activated state. The RLC entity in the inactivated state may be referred to as the inactivated RLC entity, the to-be-activated RLC entity, or the deactivated RLC entity.

The activation information may include: an activation indication and/or a deactivation indication. The activation indication may be used to activate one or more RLC entities to be activated, and the deactivation indication may be used to deactivate one or more activated RLC entities.

Only RLC entities in the activated state can be used for data transmission. In this way, the RLC entity for transmitting the target data can be dynamically updated through the activation information. In this case, the first configuration information can be a dynamically configured RRC message, which can dynamically configure one or more RLC entities for transmitting the target data. When the UE and the access device act as the transmitter, they establish the RLC entity after obtaining the first configuration information, and update the status of the established RLC entity after receiving the activation information.

In some embodiments, the first configuration information may further include: indication information for setting the initial state of each configured RLC entity. The initial state of the transmission target data may be an activated state or a deactivated state. For example, when the first configuration information configures multiple RLC entities at the same time, the initial state of the primary RLC entity among the multiple RLC entities may be the activated state, and the initial state of other secondary RLC entities may be the deactivated state.

As shown in FIG. 2G, an embodiment of the present disclosure provides an information processing method, which is executed by a transmitter and includes:

S1710: In response to the RLC entity for sending the target data being changed from the first RLC entity to the second RLC entity;

S1720: Execute the given function of the target data.

The first RLC entity and the second RLC entity are different RLC entities. The first RLC entity here can be considered as a source RLC entity for sending the target data, and the second RLC entity can be considered as a target RLC entity for sending the target data.

Exemplarily, the transmitter may determine, based on any one of the aforementioned given information, that the RLC entity for transmitting the target data is updated from the first RLC entity to the second RLC entity.

As another example, the transmitter may also determine, based on a predefined rule, that the RLC entity for transmitting the target data is updated from the first RLC entity to the second RLC entity.

As another example, the transmitter may also determine, based on a predefined rule, that the transmitting RLC entity of the target data is updated from the first RLC entity to the second RLC entity. The transmission modes of the RLC entity before the change and the RLC entity after the change may be the same or different. As an embodiment, for the target data, change can be made only between the different RLC entities supporting the same transmission mode, based on the protocol agreement, to simplify the operation.

The predefined rule may include: protocol agreement. For example, the predefined rule implements: defining a trigger condition for updating the sending RLC entity of one or more target data, and if the trigger condition is met, determining that the sending RLC entity of the target data is updated from the first RLC entity to the second RLC entity.

Due to the switching of the RLC entity for sending the target data, there may be a gap in sending the target data, and a QoS update between the first RLC entity and the second RLC entity for processing the target data.

The given function may be a data reliability ensuring function and/or a data delay ensuring function.

The data reliability ensuring function is mainly used to ensure the reliability of data transmission.

The data delay ensuring function is mainly used to ensure that the data transmission delay is within the tolerable delay range and reduce data timeouts.

For example, if the QoS guarantee of the second RLC entity is improved relative to that of the first RLC entity, it means that the target data needs a higher QoS guarantee, and at this time, it may be necessary to perform a data reliability ensuring function related to data reliability. If the QoS guarantee of the second RLC entity is reduced relative to that of the first RLC entity, and more attention is paid to data transmission delay, it may be necessary to perform a data delay ensuring function related to data delay.

In summary, by executing the given function, the QoS after updating the sending RLC entity of the target data can be met, and the QoS guarantee in the updating process of the sending RLC entity can be achieved.

Exemplarily, the second RLC entity includes:
The RLC entity has been established in the transmitter;
and/or,

The RLC entity is to be established in the transmitter.

In some embodiments, executing the given function of the target data based on the second RLC entity includes:
performing a given operation corresponding to the transmission mode with the second RLC entity; or,
enabling the PDCP data recovery function.

The given operation may be related to the updated transmission mode of the second RLC entity. The transmission mode of the second RLC entity reflects the updated QoS requirement of the RLC for sending the target data, so the given operation based on the transmission mode of the second RLC entity can at least meet the updated QoS requirement of the RLC for sending the target data.

For the related operations of the PDCP data recovery function, reference may be made to the related art, and the PDCP data recovery function may be used to achieve QoS guarantee during the process of updating the RLC for sending the target data.

The performing the given operation corresponding to the transmission mode of the second RLC entity, including:
in response to the transmission mode of the second RLC entity being AM, determining to send the first PDCP data unit and the second PDCP data unit to the second RLC entity;
or,
in response to the transmission mode of the second RLC entity being TM or UM, determining to send a second PDCP data unit to the second RLC entity;
where the first PDCP data unit includes: a PDCP data unit that has been sent to the first RLC entity and for which feedback data is not received; and the second PDCP data unit includes: a PDCP data unit that has not been sent to the first RLC entity.

If the transmission mode of the updated second RLC entity is AM, it means that the target data has a very high QoS requirement. The data transmission interruption or data packet loss caused by the RLC entity update causes phenomena such as data decoding failure or transmission failure. Therefore, in this case, as the first PDCP data unit sent by the transmitter, as long as the feedback data from the receiver is not received, it can be sent again through the second RLC entity for the purpose of ensuring data reliability. The feedback data may include: ACK indicating successful reception and/or NACK indicating failed reception. The PDCP layer of the receiver sends the feedback data to the PHY layer of the transmitter, and transmits it to the PDCP layer through the MAC layer and the RLC layer in turn. If the second PDCP data unit is the target data that has not been sent by the first RLC, it can continue to be sent by the second RLC to ensure that the receiver receives the complete target data.

If the transmission mode of the second RLC entity is UM or TM, especially TM, it means that the reliability requirement for the target data is currently low, and a higher transmission rate may be required. At this time, the second RLC entity can be used directly to send the second PDCP data unit by default, at least the first PDCP data unit is not sent when the given function is executed. The QoS guarantee for data reliability provided by UM is lower than the QoS guarantee for data reliability provided by AM. In order to reduce unnecessary data packet transmission, when the transmission mode of the second RLC entity is UM, the first PDCP data unit may not be transmitted preferentially, and the second PDCP data unit may be sent preferentially.

In some embodiments, performing the given operation corresponding to the transmission mode of the second RLC entity includes:
triggering the receiver to send a PDCP status report;
based on the PDCP status report, determining whether to send part or all of the first PDCP data unit to the second RLC entity or whether to delete the sent first PDCP data unit.

The PDCP status report indicates the PDCP data units that have been successfully received by the receiver, and/or the PDCP data units that have failed to be received by the receiver.

Exemplarily, triggering the receiver to send the PDCP status report may include: if the transmission mode of the second RLC entity is AM, triggering the receiver to send the PDCP status report. In this way, the PDCP entity of the transmitter can send the data that needs to be continued to be sent to the receiver via the second RLC entity or delete the successfully sent PDCP data unit based on the PDCP status report of the receiver.

In some embodiments, enabling the PDCP data recovery function includes:

After enabling the PDCP data recovery function, a first PDCP data unit and a second PDCP data unit are sent to the second RLC entity; wherein, the first PDCP data unit includes: a PDCP data unit that has been sent to the first RLC entity and for which feedback data is not received; the second PDCP data unit includes: a PDCP data unit that has not been sent to the first RLC entity.

In the disclosed embodiment, if the RLC entity for sending the target data is updated, the PDCP data recovery function is enabled. In this case, regardless of the transmission mode of the updated second RLC entity, the first PDCP data unit that has been sent and for which feedback data is not received and the second PDCP data unit are provided to the second RLC entity, and are processed by the second RLC entity and sent to the receiver.

The feedback data includes but is not limited to ACK and/or NACK.

In this way, the PDCP data recovery function can be used to ensure the reliability of data transmission during the process of replacing (i.e., updating) the RLC entity.

As shown in FIG. 2H, an embodiment of the present disclosure provides an information processing method, which is executed by a transmitter and includes:

S1810: In response to changing the RLC entity for sending the target data from the first RLC entity to the second RLC entity;

S1820: In response to the second RLC entity being the RLC entity to be established, establish the second RLC entity.

In an embodiment of the present disclosure, if the transmitter determines to replace with a second RLC entity based on given information or predefined rules. If it is detected that the transmitter has not established the second RLC entity, the second RLC entity needs to be established first. For example, the second RLC entity is established based on the first configuration information, the second configuration information or the predefined rule. After the second RLC entity is established, the established second RLC entity used before executing the given function, or before deleting, releasing or reestablishing the first RLC entity.

It should be noted that: when it is determined to change the RLC entity for sending the target data from the first RLC entity to the second RLC entity, the use of the first RLC entity to send data can be suspended, or the first RLC entity can continue to be used to send data until the second RLC entity is established and can take over the first RLC entity to send data.

Exemplarily, if the reliability of the second RLC entity is higher than that of the first RLC entity, when it is determined that the RLC sending the target data is changed to the second RLC entity, the data transmission of the first RLC entity can be suspended before the second RLC entity is established, so as to better ensure the transmission reliability of the target data. Here, the reliability of the second RLC entity is higher than that of the first RLC entity in one or more of the following aspects: the transmission mode of the first RLC entity is TM, and the transmission mode of the second RLC entity is AM or UM; or, the transmission mode of the first RLC entity is UM, and the transmission mode of the second RLC entity is AM; or, the bandwidth corresponding to the logical channel mapped by the first RLC entity is less than the bandwidth corresponding to the logical channel mapped by the second RLC entity, etc.

As another example, if the reliability of the second RLC entity is lower than the reliability of the first RLC entity, the first RLC entity may continue to be used to send data before the establishment of the second RLC entity is completed to ensure data transmission delay.

In some embodiments, the method further includes: releasing or reconstructing or deactivating the first RLC entity. If the first RLC entity is released, it is equivalent to that the RLC layer at the transmitter deletes the first RLC entity. If the first RLC entity is reconstructed, a new first RLC entity may be re-established based on the new configuration information. The transmission mode and/or mapped logical channel of the newly-created first RLC entity may be different from the original first RLC entity, but the identification information of the reconstructed first RLC entity may remain the same. Of course, this is just an example, and the specific implementation is not limited to this example.

If the first RLC entity is merely deactivated, which is equivalent to the first RLC entity entering a deactivated (or disabled) state in which no data is sent, the first RLC entity may be activated again later to send data.

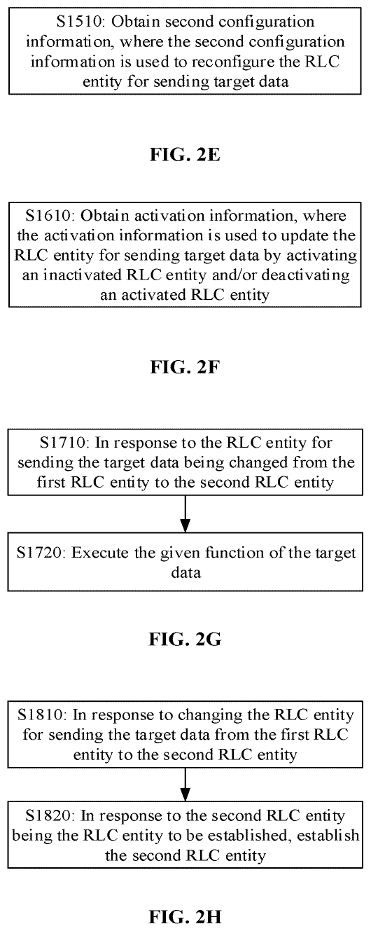

As shown in FIG. 3A, an embodiment of the present disclosure provides an information processing method, which is executed by an access device and includes:

S2110: Send first configuration information to the UE; wherein the first configuration information includes: identification information indicating the RLC entity for sending the target data; and second attribute information indicating the attributes of the data that can be transmitted by the RLC entity for sending the target data.

The execution device of the information processing method may be an access device. The access device may be the access device shown in FIG. 1, and may specifically include an eNB and/or a gNB.

If the UE is used as a transmitter, the access device pre-generates the first configuration information and sends the first configuration information to the UE. Exemplarily, the access device sends the first configuration information to the UE via an RRC message. Specifically, the RRC message used in the process of the UE switching from a non-connected state to a connected state sends the first configuration information to the UE. More specifically, the RRC message used in the process of the UE switching from other cells or reselecting to the current cell sends the first configuration information to the UE.

For example, the first configuration information is sent to the UE through an RRC connection establishment message, an RRC connection recovery message, or a random access response message.

In some embodiments, the first configuration information may be semi-static configuration information or dynamic configuration information.

Exemplarily, the first configuration information may be a list of RLC entities. The list may include identification information of the RLC entities, for example, the identification information may include the serial number of the RLC entity. At the same time, the list may also include second attribute information located in the same row as the identification information of each RLC entity.

Exemplarily, one piece of identification information may be used to identify an RLC entity established by the RLC layer of the UE. The RLC entity indicated by the identification information may be an established RLC entity and/or an RLC entity to be established.

The second attribute information may indicate any information characterizing its QoS requirements, such as the importance level and/or priority and/or service type of the data that the RLC entity intends to (or expects to) transmit. Exemplarily, the second attribute information may also be any information such as the importance level and/or priority and/or service type.

In another exemplary embodiment, the first configuration information may include one or more fields. One field may be used to configure an RLC entity of the RLC layer of the UE. For example, different parts of one field may carry identification information and second attribute information of the RLC entity to be established.

The first configuration information may be an RLC configuration for control data or service data. The RLC entity to be established may include one or more RLC entities, and different types of RLC entities may provide higher QoS guarantees. Exemplarily, the RLC entity may include: a primary RLC entity and a secondary RLC entity, and the primary RLC entity may provide higher QoS guarantees than the secondary QoS entity.

The first configuration information further includes:
mode information, indicating a transmission mode of an RLC entity transmitting the target data;
the transmission modes include: Transparent Mode (TM), Unacknowledged Mode (UM) and/or Acknowledged Mode (AM).

The transparent transmission mode may be a transmission mode in which PDU is not converted into SDU, RLC header is not added, and data is not discarded, reordered, reassembled, or error corrected.

The unacknowledged mode may be a transmission mode in which the PDU is converted into an SDU, an RLC header is added to the SDU, and data is discarded, rearranged and/or reassembled.

The acknowledged mode may be a transmission mode in which the PDU is converted into an SDU, an RLC header is added to the SDU, and data is discarded, reordered, reassembled, and/or error corrected.

The transmission modes of different RLC entities may be different. For example, an RLC entity using AM may provide a higher QoS guarantee for data transmission than an RLC entity using UM. And an RLC entity using UM may provide a higher QoS guarantee for data transmission than an RLC entity using TM.

In some embodiments, the first attribute information includes one or more of the following;
importance level;
service type;
quality of service (QoS) flow identifier;
sub-QoS flow identifier; or
priority.

As shown in FIG. 3B, an embodiment of the present disclosure provides an information processing method, which is executed by an access device and includes:

S2210: Send first configuration information to the UE; wherein the first configuration information includes: identification information indicating the RLC entity for sending the target data; and second attribute information indicating the attribute of the data that can be transmitted by the RLC entity for sending the target data.

S2220: Send second configuration information, wherein the second configuration information is used to reconfigure the RLC entity for sending target data.

Sending the second configuration information here may include: sending the second configuration information to the UE, exemplarily, broadcasting, multicasting or unicasting the second configuration information to the UE.

Exemplarily, the second configuration information may be used to implement at least one of the following functions:

Disable or enable the splitting function of the target data; if the splitting function is enabled, at least two RLCs are used to send the target data;
Add the RLC entity for sending the target data;
Reduce the RLC entity for sending the target data;
Replace the RLC entity for sending the target data;
Update the second attribute information of the RLC entity for sending the target data;
Update the transmission mode of the RLC entity for sending the target data; and
Update the logical channel or logical channel group mapped by the RLC entity for sending the target data.

In some embodiments, the second configuration information may also be any data sent by the access device for reconfiguring the RLC entity for sending the target data. The second configuration information may be configured by an RRC reconfiguration message, an RRC reestablishment message or an RRC recovery message.

Exemplarily, both the first configuration information and the second configuration information may be semi-static configuration information and/or dynamic configuration information.

In some embodiments, the second configuration information may also include: a list of RLC entities. The list may include at least: identification information of the second RLC entity; and/or second attribute information corresponding to each second RLC entity, and/or mode information of the second RLC entity, and/or identification information of a logical channel or a logical channel group corresponding to the second RLC entity.

The second attribute information may indicate any information characterizing its QoS requirements, such as the importance level and/or priority level and/or service type of the data that the second RLC entity intends to (or expects to) transmit. Exemplarily, the second attribute information may also be any information such as the importance level and/or priority level and/or service type.

In another exemplary embodiment, the second configuration information may include one or more fields. One field may be used to configure an RLC entity of the RLC layer of the UE. For example, different parts of one field may carry identification information and second attribute information of the RLC entity to be established.

The second configuration information further includes: mode information indicating a transmission mode of the second RLC entity. The transmission mode of the second RLC entity may be AM, UM or TM.

In the embodiment of the present disclosure, the second RLC may be configured to obtain the second configuration information based on the updated QoS requirement of the target data.

As shown in FIG. 3C, an embodiment of the present disclosure provides an information processing method, which is executed by an access device and includes:

S2310: Send first configuration information to the UE; wherein the first configuration information includes: identification information indicating the RLC entity for sending the target data; and second attribute information indicating the attributes of the data that can be transmitted by the RLC entity for sending the target data.

S2320: Send activation information, where the activation information is used to update the RLC entity for sending target data by activating an inactivated RLC entity and/or deactivating an activated RLC entity.

The activation information may be carried by a MAC layer message or a DCI. Exemplarily, the MAC layer message may include but is not limited to a MAC CE.

Exemplarily, the first configuration information may perform initial configuration or update configuration on the RLC entity for sending the target data. In this case, the first configuration information completes the configuration of the RLC entity, and the activation of the configured RLC entity may be implemented by the activation information. In a specific implementation process, the initial activation of the RLC entity configured by the first configuration information may also be completed by the first configuration information, or the default initial state is an activated state or an inactivated state.

Exemplarily, the activation information may be used for state switching of an established RLC entity from a deactivated state to an activated state.

The activation information may include: an activation indication and/or a deactivation indication. The activation indication may be used to activate one or more RLC entities to be activated, and the deactivation indication may be used to deactivate one or more activated RLC entities.

Exemplarily, sending the activation information includes: sending a MAC CE carrying the activation information.

In some embodiments, the activation information includes:

An activation indication, used to activate at least one inactivated RLC entity configured by the first configuration information;
and/or,

A deactivation indication is used to deactivate at least one activated RLC entity configured by the first configuration information.

In some embodiments, the access device configures the RLC entity of the target data sent uplink by the UE, and the access device, as the transmitter of the downlink transmission, can send the target data to the UE based on the first configuration information, and one of the second configuration information and the activation information.

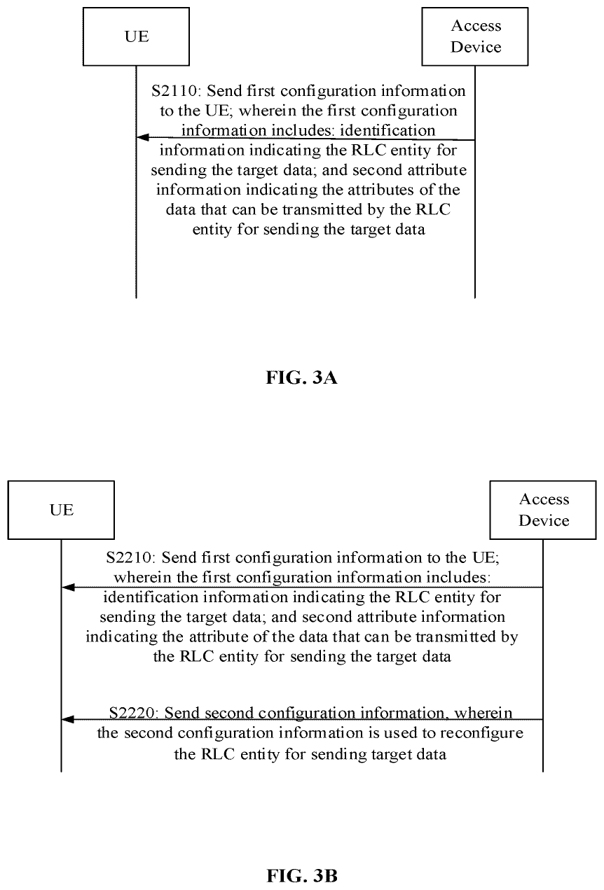

As shown in FIG. 4A, an embodiment of the present disclosure provides an information processing method, which is executed by a user equipment (UE) and includes:

S3110: Receive first configuration information sent by the access device; wherein the first configuration information includes: identification information indicating the RLC entity for sending the target data; and second attribute information indicating the attributes of the data that can be transmitted by the RLC entity for sending the target data.

The execution device of the information processing method may be a UE. The UE may be various types of communication devices, specifically the device shown in FIG. 1.

The access device may be any RAN device.

If the UE is used as a transmitter, the access device pre-generates the first configuration information and sends the first configuration information to the UE. Exemplarily, the access device sends the first configuration information to the UE via an RRC message. Specifically, the RRC message used in the process of the UE switching from a non-connected state to a connected state sends the first configuration information to the UE. More specifically, the RRC message used in the process of the UE switching from other cells or reselecting to the current cell sends the first configuration information to the UE.

For example, the first configuration information is sent to the UE through an RRC connection establishment message, an RRC connection recovery message, or a random access response message.

In some embodiments, the first configuration information may be semi-static configuration information or dynamic configuration information.

Exemplarily, the first configuration information may be a list of RLC entities. The list may include identification information of the RLC entities, for example, the identification information may include the serial number of the RLC entity. At the same time, the list may also include second attribute information located in the same row as the identification information of each RLC entity.

Exemplarily, one piece of identification information may be used to identify an RLC entity established by the RLC layer of the UE. The RLC entity indicated by the identification information may be an established RLC entity and/or an RLC entity to be established.

The second attribute information may indicate any information characterizing its QoS requirements, such as the importance level and/or priority and/or service type of the data that the RLC entity intends to (or expects to) transmit. Exemplarily, the second attribute information may also be any information such as the importance level and/or priority and/or service type.

In another exemplary embodiment, the first configuration information may include one or more fields. One field may be used to configure an RLC entity of the RLC layer of the UE. For example, different parts of one field may carry identification information and second attribute information of the RLC entity to be established.

The first configuration information may be an RLC configuration for control data or service data. The RLC entity to be established may include one or more RLC entities, and different types of RLC entities may provide higher QoS guarantees. Exemplarily, the RLC entity may include: a primary RLC entity and a secondary RLC entity, and the primary RLC entity may provide higher QoS guarantees than the secondary QoS entity.

The first configuration information further includes:
mode information, indicating a transmission mode of an RLC entity transmitting the target data;
the transmission modes include: Transparent Mode (TM), Unacknowledged Mode (UM) and/or Acknowledged Mode (AM).

The transparent transmission mode may be a transmission mode in which PDU is not converted into SDU, RLC header is not added, and data is not discarded, reordered, reassembled, or error corrected.

The unacknowledged mode may be a transmission mode in which the PDU is converted into an SDU, an RLC header is added to the SDU, and data is discarded, rearranged and/or reassembled.

The acknowledged mode may be a transmission mode in which the PDU is converted into an SDU, an RLC header is added to the SDU, and data is discarded, reordered, reassembled, and/or error corrected.

The transmission modes of different RLC entities may be different. For example, an RLC entity using AM may provide a higher QoS guarantee for data transmission than an RLC entity using UM. And an RLC entity using UM may provide a higher QoS guarantee for data transmission than an RLC entity using TM.

In some embodiments, the first attribute information includes one or more of the following;
importance level;
service type;
quality of service (QoS) flow identifier;
sub-QoS flow identifier; or
priority.

As shown in FIG. 4B, an embodiment of the present disclosure provides an information processing method, which is executed by a UE and includes:

S3210: Receive first configuration information sent by the access device; wherein the first configuration information includes: identification information indicating the RLC entity for sending the target data; and second attribute information indicating the attribute of the data that can be transmitted by the RLC entity for sending the target data.

S3220: Receive second configuration information, wherein the second configuration information is used to reconfigure the RLC entity for sending target data.

The first configuration information may be initial configuration information, which is used to initially configure the RLC entity for sending the target data. In some cases, if the QoS requirement of the target data does not change or changes slightly, then there is no need to update the RLC entity for sending the target data before the target data stops transmitting, and the UE dos not receive the second configuration information sent by the access device.

If the QoS requirement changes during the transmission of the target data, the second configuration information sent by the access device may be received.

Exemplarily, the second configuration information may be used to implement at least one of the following functions:

Disable or enable the splitting function of the target data; if the splitting function is enabled, at least two RLCs are used to send the target data;
Add the RLC entity for sending the target data;
Reduce the RLC entity for sending the target data;
Replace the RLC entity for sending the target data;
Update the second attribute information of the RLC entity for sending the target data;
Update the transmission mode of the RLC entity for sending the target data; and
Update the logical channel or logical channel group mapped by the RLC entity for sending the target data.

In some embodiments, the second configuration information may also be any data sent by the access device for reconfiguring the RLC entity for sending the target data. The second configuration information may be configured by an RRC reconfiguration message, an RRC reestablishment message or an RRC recovery message.

Exemplarily, both the first configuration information and the second configuration information may be semi-static configuration information and/or dynamic configuration information.

In some embodiments, the second configuration information may also include: a list of RLC entities. The list may include at least: identification information of the second RLC entity; and/or second attribute information corresponding to each second RLC entity, and/or mode information of the second RLC entity, and/or identification information of a logical channel or a logical channel group corresponding to the second RLC entity.

The second attribute information may indicate any information characterizing its QoS requirements, such as the importance level and/or priority level and/or service type of the data that the second RLC entity intends to (or expects to) transmit. Exemplarily, the second attribute information may also be any information such as the importance level and/or priority level and/or service type.

In another exemplary embodiment, the second configuration information may include one or more fields. One field may be used to configure an RLC entity of the RLC layer of the UE. For example, different parts of one field may carry identification information and second attribute information of the RLC entity to be established.

The second configuration information further includes: mode information indicating a transmission mode of the second RLC entity. The transmission mode of the second RLC entity may be AM, UM or TM.

In the embodiment of the present disclosure, the second RLC may be configured to obtain the second configuration information based on the updated QoS requirement of the target data.

As shown in FIG. 4C, an embodiment of the present disclosure provides an information processing method, which is executed by a UE and includes:

S3310: Receive first configuration information sent by the access device; wherein the first configuration information includes: identification information indicating the RLC entity for sending the target data; and second attribute information indicating the attributes of the data that can be transmitted by the RLC entity for sending the target data.

S3320: Receive activation information, where the activation information is used to update the RLC entity for sending target data by activating an inactivated RLC entity and/or deactivating an activated RLC entity.

The activation information may be carried by a MAC layer message or a DCI. Exemplarily, the MAC layer message may include but is not limited to a MAC CE.

Exemplarily, the first configuration information may perform initial configuration or update configuration on the RLC entity for sending the target data. In this case, the first configuration information completes the configuration of the RLC entity, and the activation of the configured RLC entity may be implemented by the activation information. In a specific implementation process, the initial activation of the RLC entity configured by the first configuration information may also be completed by the first configuration information, or the default initial state is an activated state or an inactivated state.

Exemplarily, the activation information may be used for state switching of an established RLC entity from a deactivated state to an activated state.

The activation information may include: an activation indication and/or a deactivation indication. The activation indication may be used to activate one or more RLC entities to be activated, and the deactivation indication may be used to deactivate one or more activated RLC entities.

This embodiment provides an information processing method related to a function of performing traffic splitting based on data attributes at a PDCP layer, which may include:

In a specific service splitting scenario, the network configures the PDCP entity to correspond to N types of RLC entities; where N corresponds to the service type classification. The specific service may include but is not limited to XR services. N is an arbitrary positive integer. Different types of RLC entities provide different QoS guarantees.

As an embodiment; the PDCP layer specifies the transmission RLC entity for different service types, for example, configures a list (first field) for RLC entity transmission corresponding to two service types. That is, the list may be categorized based on configuring different or the same RLC entities for different service types. In addition, the control data of the PDCP layer, for example, the PDCP carrying control data The PDU is transmitted from the RLC entity specified by the agreement or access device.

In some embodiments, it is assumed that the first RLC entity is used for type 1 data transmission and the second RLC entity is used for type 2 data transmission.

The service type classification dimensions may include one or more of the following:
dimensions such as importance level, service type, QoS flow ID or sub QoS flow ID, and priority level of the data.

As an embodiment, the RLC entities associated with the same PDCP entity may be in the same RLC transmission mode or in different RLC transmission modes. The RLC transmission mode here may be the transmission mode of the RLC entity.

As an embodiment, for a radio bearer (RB), its PDCP layer performs a splitting function and a PDCP duplication function based on attributes, which are not configured at the same time, or are not enabled at the same time. The attributes here include, but are not limited to, service attributes and/or data attributes of the target data. Service attributes can be reflected by service identifiers, service types and/or QoS parameters of services. Data attributes can be reflected by data types, and/or dependencies or dependency relationships between different data. As an embodiment, the first field and the second field (MoreThanTwoRLC-DRB) are not configured at the same time. The first field here is used to configure the splitting function of the attribute-based PDCP; the second field is used to configure the PDCP duplication function.

In some embodiments, the PDCP function of performing traffic splitting based on service attributes and the PDCP duplication function can be enabled at the same time. When the splitting function is enabled, PDCP data units of different importance levels or different service attributes can be sent through different RLC entities. For example, data with high importance levels can be sent in different RLC entities based on the duplication function, while unimportant data does not need to be sent in multiple RLC entities.

As an embodiment, for a radio bearer (RB), the PDCP layer's splitting function based on service attributes and the PDCP layer's splitting function based on service volume size are not configured at the same time, or are not enabled at the same time.

As an embodiment, the first field and the third field (MoreThanOneRLC) are not configured at the same time. The third field here is used to configure the PDCP layer's splitting function based on the service volume (or data volume). If the third field configures the PDCP layer's splitting function based on the data volume, the PDCP layer uses different RLC entities to send data when the data volume reaches the threshold value.

In some embodiments, the PDCP's attribute-based splitting function and the PDCP layer's splitting function based on the size of the service volume can be enabled at the same time. That is, for data in a certain scenario, splitting can be performed based on the attributes, and at the same time, splitting can be performed based on the size of the data. For example, the split data can be based on the Master Cell Group (MCG) and the Secondary Cell Group (SCG). The master cell group includes at least the master cell. In some scenarios, the master cell group also includes one or more other cells other than the master cell. The secondary cell includes one or more secondary cells. The logical channels mapped by different RLC entities may belong to the same cell group or different cell groups. For example, the logical channel mapped by the main RLC entity may belong to the main cell group, and the logical channel mapped by the secondary RLC entity may belong to the secondary cell group.

In some embodiments, for one type of service data, two RLC entities are configured, namely, a first RLC entity and a second RLC entity, and the first RLC entity can be used for type 1 data transmission and the second RLC entity can be used for type 2 data transmission. The transmission modes of the first RLC entity and the second RLC entity are both configured as UM or AM. Exemplarily, the transmission mode of the first RLC entity is configured as UM, and the transmission mode of the second RLC entity can be configured as AM.

Example 2: For one type of service data, two RLC entities are configured, namely, a first RLC entity and a second RLC entity, and the first RLC entity can be used for type 1 data transmission and the second RLC entity can be used for type 2 data transmission. The transmission modes of the first RLC entity and the second RLC entity are both configured as TM, UM or AM.

In some embodiments, the network device uses RRC messages to configure or change the configuration of service splitting.

As an embodiment, a transmission channel of a specific data type is switched from a first RLC entity to a second RLC entity. The specific data may include but is not limited to the service data of the aforementioned specified service. At this time, the second RLC entity may be an old RLC entity that has been established, or a new RLC entity that needs to be re-established.

As an embodiment; the change of service splitting also includes switching from split sending to non-split sending based on the data sending method. For example, by disabling or deactivating the configuration information of split sending, the data sending method is switched from split sending to non-split sending. That is, returning to the original sending method that does not split based on the service type. For example, by enabling or activating the configuration information of split sending, the data sending method is switched from non-split sending to split sending. That is, returning to the original sending method that performs split according to the service type.

As an embodiment; when the service splitting configuration is changed, it is accompanied by the given function of data processing.

When executing the given function, an example of a behavior of the UE may be as follows:

If the transmission mode used by the DRB or RLC entity for the data to be sent is AM, the data units transmitted on the original RLC entity and not yet confirmed to be successfully sent are retransmitted on the new target RLC entity starting from the first data unit that has not been confirmed to be successfully sent, or the data units that have been associated with the serial number (SN) but have not been transmitted on the original RLC entity in time are transmitted in sequence on the new target RLC entity.

Exemplarily, each time the PDCP layer sends a PDCP data unit to the RLC layer, the counter performs a count. The count value can be used as the aforementioned SN. That is, the PDCP data unit that the PDCP entity has sent to the RLC entity is associated with the SN. In this way, the transmitter can retransmit, based on the current count value of the counter and the SN of the PDCP data unit for which a successful transmission confirmation has been received, the PDCP data unit that has been transmitted on the original RLC but for which successful transmission confirmation is not received on the new target RLC entity, or retransmit the data unit that has been associated with the SN but has not yet been transmitted on the original RLC entity.

When executing the given function, another behavior example of the UE may be as follows:

If the transmission mode used by the DRB or RLC entity for the data to be sent is UM, for all PDCP SDUs that have been processed by PDCP but not yet submitted to the lower layer, the PDCP SDUs that have not yet been sent are transmitted to the target RLC entity in ascending order of the sequence number (SN) of the PDCP SDU corresponding to the count value of the counter. The target RLC entity continues to send the data.

As an embodiment, when the service splitting configuration is changed, the given function of data processing is executed.

This process can be a data recovery process of the PDCP layer (PDCP data recovery). For example, due to a change in the service splitting configuration, at least one RLC entity may not be able to continue transmission. At this time, the PDCP entity can retransmit through the changed RLC entity that is available based on the feedback data of the data sent by the RLC entity and the PDCP data unit for which the acknowledgement character (ACK) is not received, so as to ensure the reliability of the data.

When executing the given function, another behavior example of the UE may be as follows:

For data in AM transmission mode, when the upper layer requests the PDCP layer to recover the data of the radio bearer, the PDCP entity retransmits the previously sent PDCP data unit for which the data indicating successful delivery is not received.

The upper layer here includes but is not limited to: Service Data Adaptation Protocol (SDAP).

The above PDCP data unit may be a PDCP data PDU or a PDCP SDU. The PDCP data PDU may be referred to as a PDCP PDU for short.

Furthermore: the access device can carry the instructions for the terminal to perform given function in the sent RRC message that changes the service splitting configuration. For example, the access device sends an instruction message to instruct the sender to perform the PDCP layer data recovery process (PDCP data Recovery).

In some embodiments, the RLC entity sending data switches from the first RLC entity to the newly established second RLC entity for transmission, and the first RLC entity is reestablished or released or cannot continue to transmit the originally split data, then the aforementioned given function can be implemented by one or more of the following operations:
Enable the PDCP data recovery function;
Establish a second RLC entity;
The MAC entity associated with the first RLC entity is reconfigured;
The MAC entity associated with the second RLC entity is established or reconfigured; and
If the first RLC entity and the second RLC entity share a MAC entity, the MAC entity is reconfigured.

In other embodiments, if the data transmission RLC entity switches from the first RLC entity to the existing second RLC entity for transmission, and the first RLC entity is reestablished or released or cannot continue to transmit the originally split data, the aforementioned given function can be implemented through one or more of the following operations.

The execution of the given function may include at least one of the following operations:
PDCP data recovery;
The MAC entity associated with the first RLC entity is reconfigured;
The MAC entity associated with the second RLC entity has no action, i.e. no subsequent operations; and
If the first RLC entity and the second RLC entity share a MAC entity, the MAC entity is reconfigured.

In some embodiments, the RRC message configures the first RLC entity for type 1 data transmission, and the second RLC entity for type 2 data transmission. After a period of time, the access device reconfigures the first RLC entity for both type 1 data transmission and type 2 data transmission through a new RRC message, that is, the original second RLC entity is deleted, and a PDCP data recovery operation is required at this time. The purpose is to retransmit the data originally transmitted on the second RLC entity and not confirmed to be received by the receiver.

In some embodiments, when the access device changes the service splitting configuration, it triggers the receiver to report the PDCP status report. If the access device configures the receiver to report the PDCP status report, the transmitter can receive the PDCP status report sent by the opposite device (i.e., the receiver) and perform operations related to data transmission reliability based on the PDCP status report.

In addition to using the RRC messages to configure or change service splitting, the access device can also activate or deactivate the splitting state more dynamically by way of MAC CE.

As an embodiment, the access device first configures the service splitting using an RRC message, and while configuring the RLC entity, it can also indicate the initial state of the split RLC entity. That is, the initial state may include: an activated state or a deactivated state. The activated state may also be referred to as an enabled state. The deactivated state may also be referred to as a disabled state.

Then, when deactivating the service splitting of a specific RLC entity using the MAC CE, the RLC entity does not re-establish, and the HARQ buffer of the MAC layer is not cleared. At this time, the split data packets is discarded based on the received PDCP indication. For example, the RLC entity discards the split data packets.

Data packets that have not been transmitted in time at the MAC need to be discarded, but data packets that have been delivered to the MAC cannot be deleted, so the HARQ buffer is not cleared.

In the embodiment, when activating the splitting or deactivating the splitting state more dynamically by way of MAC CE, it can also be accompanied by the above given functions. Because the deactivated RLC entity cannot continue to transmit specific types of data at this time, it is necessary to continue to transmit unconfirmed data packets or data packets that have not been sent in time on the new RLC entity.

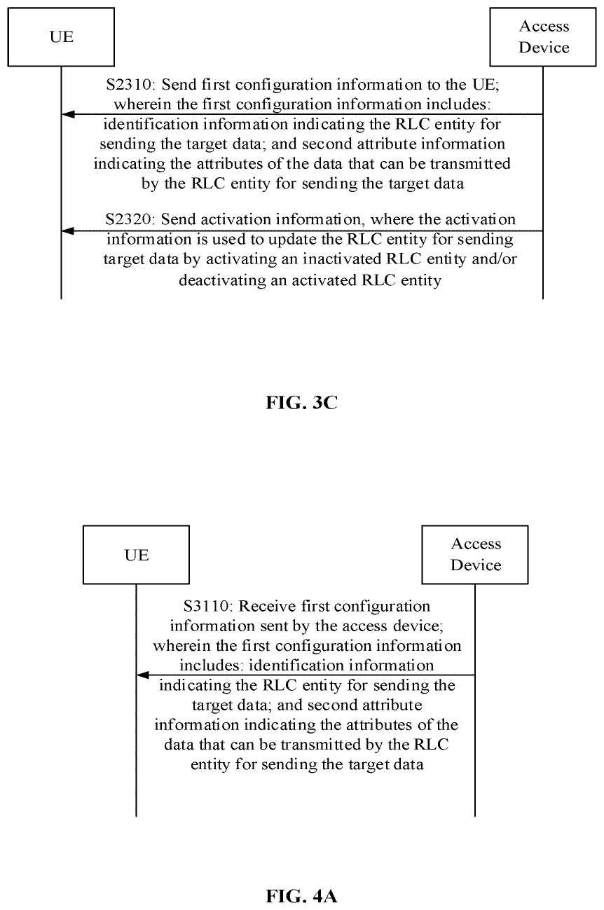

As shown in FIG. 5, an embodiment of the present disclosure provides an information processing apparatus, apparatus the device includes:

a determining module 110, configured to determine a radio link control (RLC) entity to send target data based on first attribute information of the target data to be sent.

The information processing apparatus may be a transmitter. The transmitter may be a UE or an access device.

In some embodiments, the information processing apparatus may further include a storage module. The storage module is connected to the determining module 110 and is used to store any information required in the execution process of determining the radio link control (RLC) entity for sending the target data based on the first attribute information of the target data to be sent.

In some embodiments, the determining module 110 may be a program module, and after the program module is executed by a processor, the above operations can be implemented.

In some other embodiments, the determining module 110 may be a software-hardware combination module; the software-hardware combination module may include: a programmable array. The programmable array includes but is not limited to a field programmable array and/or a complex programmable array.

In some other embodiments, the determining module 110 may be a pure hardware module; the pure hardware module includes but is not limited to a dedicated integrated circuit.

In some embodiments, the apparatus further includes:

An obtaining module, configured to obtain first configuration information before determining the RLC entity for transmitting the target data;
wherein the first configuration information includes:
identification information, indicating the RLC entity for sending the target data; and
second attribute information, indicating the attribute of data that can be transmitted by the RLC entity for sending the target data.

In some embodiments, the determining module 110 is configured to select, based on the first attribute information of the target data, an RLC entity corresponding to second attribute information matching the first attribute information to transmit the target data.

It can be understood that the first configuration information also includes:
mode information, indicating a transmission mode of an RLC entity sending target data;
wherein the transmission modes include: transparent transmission mode (TM), unacknowledged mode (UM) and/or acknowledged mode (AM).

It can be understood that the first attribute information includes one or more of the following:
importance level;
service type;
quality of service (QoS) flow identifier;
sub-QoS flow identifier; or
priority.

It can be understood that the determine module 110 is configured to:
obtain given information; wherein the given information is used to update the RLC entity for sending the target data.

It can be understood that the given information includes at least one of the following:
second configuration information, wherein the second configuration information is used to reconfigure the RLC entity for sending the target data; and
activation information, used to update the RLC entity for sending the target data by activating an inactivated RLC entity and/or deactivating an activated RLC entity.

It can be understood that the apparatus also includes:
a replacement module, configured to, response to the sending RLC entity of the target data being replaced from the first RLC entity to the second RLC entity; and
an execution module, configured to execute the given function of the target data.

It can be understood that the second RLC entity includes:
the RLC entity has been established;
and/or,
the RLC entity is to be established.

It can be understood that the execution module is configured to perform a given operation corresponding to the transmission mode of the second RLC entity; or enable the PDCP data recovery function.

It can be understood that performing a given operation corresponding to the transmission mode with the second RLC entity includes:
in response to the transmission mode of the second RLC entity being AM, determining to send the first PDCP data unit and the second PDCP data unit to the second RLC entity;
or,
in response to the transmission mode of the second RLC entity being TM or UM, determining to send a second PDCP data unit to the second RLC entity;
wherein the first PDCP data unit includes: a PDCP data unit that has been sent to the first RLC entity and for which feedback data is not received; and the second PDCP data unit includes: a PDCP data unit that has not been sent to the first RLC entity.

It can be understood that enabling the PDCP data recovery function includes:
after enabling the PDCP data recovery function, sending a first PDCP data unit and a second PDCP data unit to the second RLC entity; wherein, the first PDCP data unit includes: a PDCP data unit that has been sent to the first RLC entity and for which feedback data is not received; and the second PDCP data unit includes: a PDCP data unit that has not yet been sent to the first RLC entity.

It can be understood that the apparatus also includes:
an establishing module, configured to establish the second RLC entity in response to the second RLC entity being the RLC entity to be established.

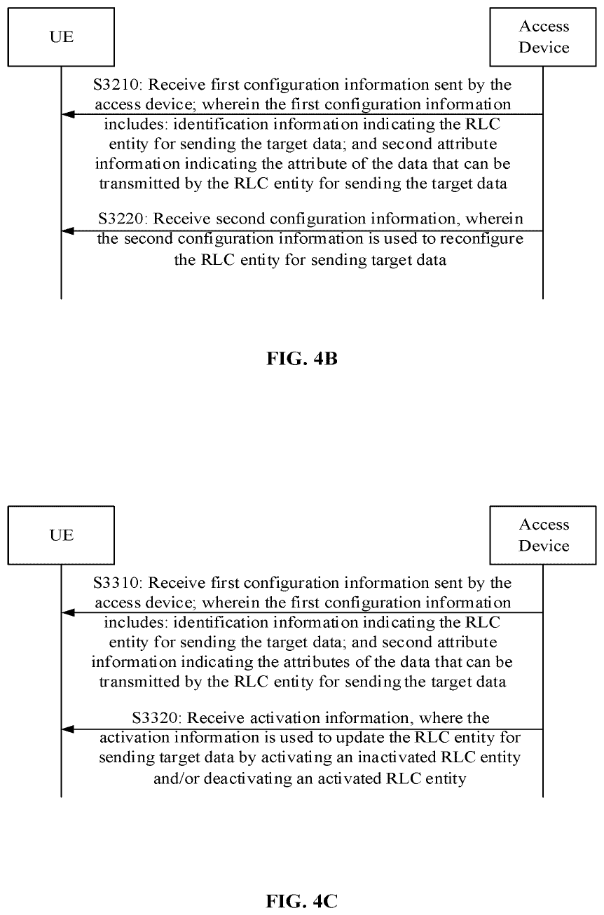

As shown in FIG. 6, an embodiment of the present disclosure provides an information processing apparatus, wherein the apparatus includes:
a sending module 210, configured to send first configuration information to a user equipment (UE); wherein the first configuration information includes:
identification information, indicating the RLC entity for sending the target data; and
second attribute information, indicating the attribute of data that can be transmitted by the RLC entity for sending the target data.

The information processing apparatus may be an access device.

In some embodiments, the sending module 210 may be a program module, and after the program module is executed by a processor, the above operations can be implemented.

In some other embodiments, the sending module 210 may be a software-hardware combination module; the software-hardware combination module may include: a programmable array. The programmable array includes but is not limited to a field programmable array and/or a complex programmable array.

In some other embodiments, the sending module 210 may be a pure hardware module; the pure hardware module includes but is not limited to a dedicated integrated circuit.

It can be understood that the first configuration information also includes:
mode information, indicating a transmission mode of the RLC entity for sending the target data; and
the transmission modes include: transparent transmission mode (TM), unacknowledged mode (UM) and/or acknowledged mode (AM).

It can be understood that the first attribute information includes one or more of the following:
importance level;
service type;
quality of service (QoS) flow identifier;
sub-QoS flow identifier; or
priority.

In some embodiments, the sending module 210 is further configured to send second configuration information, wherein the second configuration information is used to reconfigure the RLC entity for sending the target data.

In some embodiments, the sending module 210 is further configured to send activation information, where the activation information is used to update the RLC entity for sending the target data by activating an inactivated RLC entity and/or deactivating an activated RLC entity.

In some embodiments, the sending module 210 sends a medium access control (MAC) control element (CE) carrying the activation information.

It can be understood that the activation information includes:
an activation indication, used to activate at least one inactivated RLC entity configured by the first configuration information;
and/or,
a deactivation indication, used to deactivate at least one activated RLC entity configured by the first configuration information.

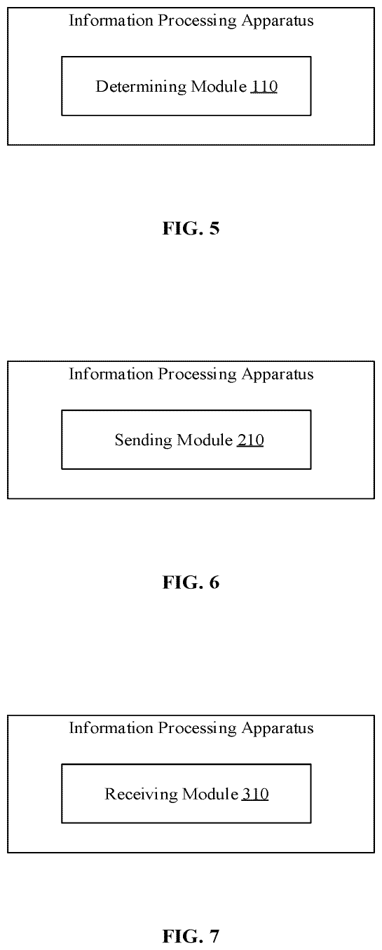

As shown in FIG. 7, an embodiment of the present disclosure provides an information processing apparatus, wherein the apparatus includes:
a receiving module 310, configured to receive first configuration information sent by an access device; wherein the first configuration information includes:
identification information, indicating an RLC entity for sending target data; and
second attribute information, indicating the attribute of data that can be transmitted by the RLC entity for sending the target data.

The information processing apparatus may be a UE.

In some embodiments, the receiving module 310 may be a program module, which can implement the above operations after being executed by a processor.

In some other embodiments, the receiving module 310 may be a software-hardware combination module; the software-hardware combination module may include: a programmable array. The programmable array includes but is not limited to a field programmable array and/or a complex programmable array.

In some other embodiments, the receiving module 310 may be a pure hardware module; the pure hardware module includes but is not limited to a dedicated integrated circuit.

It can be understood that the first configuration information also includes:
mode information, indicating a transmission mode of an RLC entity for sending target data;
the transmission modes include: transparent transmission mode (TM), unacknowledged mode (UM) and/or acknowledged mode (AM).

In some embodiments, the first attribute information includes one or more of the following;
importance level;
service type;
quality of service (QoS) flow identifier;
sub-QoS flow identifier; or
priority.

In some embodiments, the receiving module 310 is further configured to receive second configuration information, wherein the second configuration information is used to reconfigure the RLC entity for sending the target data.

In some embodiments, the receiving module 310 is further configured to receive activation information for updating the RLC entity for sending the target data by activating an inactivated RLC entity and/or deactivating an activated RLC entity.

The present disclosure provides a communication device, including:
a memory for storing processor-executable instructions; and
a processor, connected to the memory;
wherein the processor is configured to execute the information processing method provided by any of the above technical solutions. The communication device may include the above UE and/or access device.

The processor may include various types of storage media, which are non-transitory computer storage media that can continue to retain information stored thereon after the communication device loses power.

The processor may be connected to the memory via a bus or the like to read an executable program stored in the memory, to implement for example, at least one of the methods shown in FIGS. 2A to 2H, 3A to 3C, or 4A to 4B.

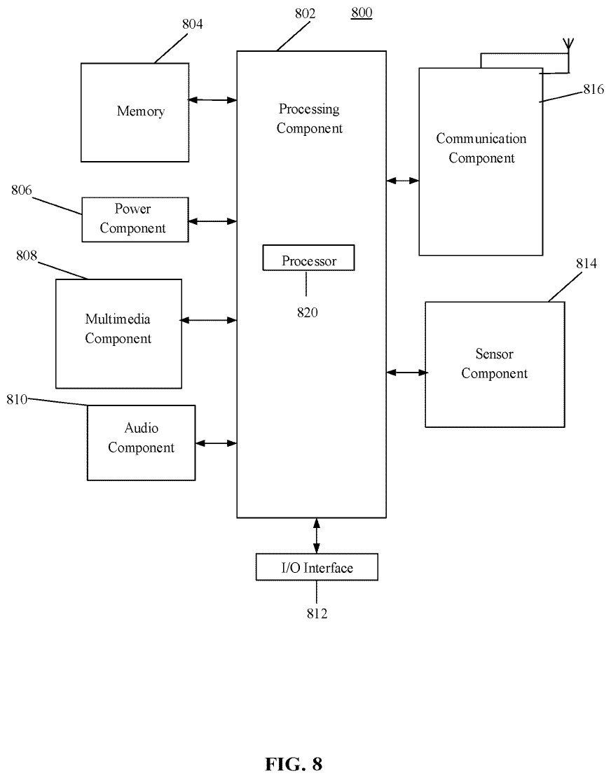

FIG. 8 is a schematic diagram showing the structure of a UE according to an exemplary embodiment. For example, the UE 800 may be a mobile phone, a computer, a digital broadcast UE, a messaging device, a game console, a tablet device, a medical device, a fitness device, a personal digital assistant, and the like.

Referring to FIG. 8, the UE 800 may include one or more of the following components: a processing component 802, a memory 804, a power component 806, a multimedia component 808, an audio component 810, an input/output (I/O) interface 812, a sensor component 814, and a communication component 816.

The processing component 802 generally controls the overall operations of the UE 800, such as operations associated with display, telephone calls, data communications, camera operations, and recording operations. The processing component 802 may include one or more processors 820 to execute instructions to generate all or part of the steps of the above method. Additionally, processing component 802 may include one or more modules that facilitate interaction between processing component 802 and other components. For example, processing component 802 may include a multimedia module to facilitate interaction between multimedia component 808 and processing component 802.

The memory 804 is configured to store various types of data to support operations at the UE 800. Examples of such data include instructions for any application or method operating on the UE 800, contact data, phonebook data, messages, pictures, videos, etc. The memory 804 can be realized by any type of volatile or non-volatile storage device or their combination, such as static random access memory (SRAM), electrically erasable programmable read only memory (EEPROM), erasable programmable read only memory (EPROM), programmable read only memory (PROM), read only memory (ROM), magnetic memory, flash memory, magnetic disk or optical disk.

The power component 806 provides power to various components of the UE 800. The power component 806 may include a power management system, one or more power supplies, and other components associated with generating, managing, and distributing power for UE 800.

The multimedia component 808 includes a screen providing an output interface between the UE 800 and the user. In some embodiments, the screen may include a liquid crystal display (LCD) and a touch panel (TP). If the screen includes a touch panel, the screen may be implemented as a touch screen to receive input signals from a user. The touch panel includes one or more touch sensors to sense touches, swipes, and gestures on the touch panel. The touch sensor may not only sense a boundary of a touch or a swipe action, but also detect duration and pressure associated with the touch or swipe operation. In some embodiments, the multimedia component 808 includes a front camera and/or a rear camera. When the UE 800 is in an operation mode, such as a photographing mode or a video mode, the front camera and/or the rear camera can receive external multimedia data. Each front camera and rear camera can be a fixed optical lens system or have focal length and optical zoom capability.

The audio component 810 is configured to output and/or input audio signals. For example, the audio component 810 includes a microphone (MIC), which is configured to receive an external audio signal when the UE 800 is in an operation mode, such as a call mode, a recording mode and a voice recognition mode. Received audio signals may be further stored in memory 804 or sent via communication component 816. In some embodiments, the audio component 810 also includes a speaker for outputting audio signals.

The I/O interface 812 provides an interface between the processing component 802 and a peripheral interface module, which may be a keyboard, a click wheel, a button, and the like. These buttons may include, but are not limited to: a home button, volume buttons, start button, and lock button.

The sensor component 814 includes one or more sensors for providing UE 800 with various aspects of status assessment. For example, the sensor component 814 can detect the open/closed state of the UE 800, the relative positioning of components, such as the display and the keypad of the UE 800, the sensor component 814 can also detect the UE 800 or a change in the position of a component of the UE 800, the presence or absence of user's contact with the UE 800, the change of orientation or acceleration/deceleration of the UE 800 and the temperature change of the UE 800. The sensor component 814 may include a proximity sensor configured to detect the presence of nearby objects in the absence of any physical contact. The sensor component 814 may also include an optical sensor, such as a CMOS or CCD image sensor, for use in imaging applications. In some embodiments, the sensor component 814 may also include an acceleration sensor, a gyroscope sensor, a magnetic sensor, a pressure sensor or a temperature sensor.

The communication component 816 is configured to facilitate wired or wireless communication between the UE 800 and other devices. The UE 800 can access a wireless network based on communication standards, such as WiFi, 2G or 3G, or a combination thereof. In an exemplary embodiment, the communication component 816 receives broadcast signals or broadcast related information from an external broadcast management system via a broadcast channel. In an exemplary embodiment, the communication component 816 also includes a near field communication (NFC) module to facilitate short-range communication. For example, the NFC module can be implemented based on radio frequency identification (RFID) technology, infrared data association (IrDA) technology, ultra wideband (UWB) technology, bluetooth (BT) technology and other technologies.

In an exemplary embodiment, UE 800 may be implemented by one or more application specific integrated circuits (ASIC), digital signal processors (DSP), digital signal processing devices (DSPD), programmable logic devices (PLD), field programmable gate array (FPGA), controllers, microcontrollers, microprocessors or other electronic components for performing the method described above.

In an exemplary embodiment, there is also provided a non-transitory computer-readable storage medium including instructions, such as the memory 804 including instructions, which can be executed by the processor 820 of the UE 800 to generate the above method. For example, the non-transitory computer readable storage medium may be ROM, random access memory (RAM), CD-ROM, magnetic tape, floppy disk, and optical data storage device, and the like.

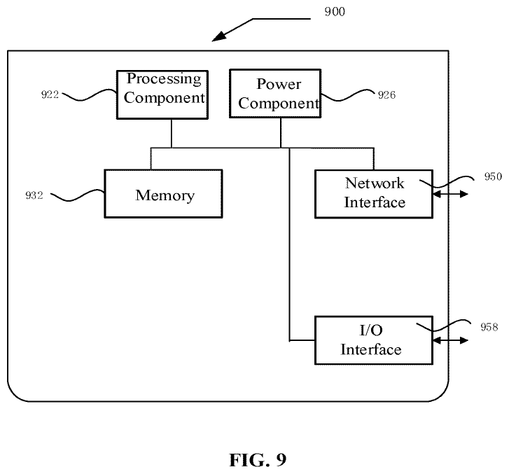

FIG. 9 is a schematic diagram showing the structure of a network device according to an exemplary embodiment. Referring to FIG. 9, the network device 900 may be provided as a network side device. Referring to FIG. 12, the network device 900 includes a processing component 922, which further includes one or more processors, and a memory resource represented by a memory 932 for storing instructions executable by the processing component 922, such as application programs. The application program stored in memory 932 may include one or more modules each corresponding to a set of instructions. In addition, the processing component 922 is configured to execute instructions, so as to perform any of the aforementioned methods applied to the access device, e.g., at least one of the methods shown in FIGS. 2A to 2H, 3A to 3C, or 4A to 4B.

The network device 900 may also include a power component 926 configured to perform power management of network device 900, a wired or wireless network interface 950 configured to connect network device 900 to a network, and an input-output (I/O) interface 958. The network device 900 can operate based on an operating system stored in the memory 932, such as Windows Server™, Mac OS X™, Unix™, Linux™, FreeBSD™ or the like.

Other embodiments of the embodiment of the present disclosure is readily apparent to those skilled in the art from consideration of the specification and practice of the invention disclosed herein. This disclosure is intended to cover any modification, use or adaptation of the embodiment of the present disclosure, these modifications, uses or adaptations follow the general principles of the embodiment of the present disclosure and include common knowledge or conventional technical means in the technical field not disclosed in this disclosure. The specification and examples are to be considered exemplary only, with a true scope and spirit of the embodiment of the present disclosure being indicated by the following claims.

It should be understood that the embodiment of the present disclosure is not limited to the precise constructions which have been described above and shown in the accompanying drawings, and various modifications and changes may be made without departing from the scope thereof. The scope of the embodiment of the present disclosure is limited only by the appended claims.

1. An information processing method, performed by a transmitter, and the method comprising:
determining a radio link control (RLC) entity for sending target data based on first attribute information of the target data to be sent.

2. The method according to claim 1, wherein before determining the RLC entity for transmitting the target data, the method further comprises:
obtaining first configuration information;
wherein the first configuration information comprises:
identification information, indicating the RLC entity for sending the target data; and
second attribute information, indicating an attribute of data that can be transmitted by the RLC entity for sending the target data.

3. The method according to claim 2, wherein determining the RLC entity for sending the target data based on the first attribute information of the target data to be sent comprises:
selecting, based on the first attribute information of the target data, the RLC entity corresponding to second attribute information matching the first attribute information for transmitting the target data.

4. The method according to claim 2, wherein the first configuration information further comprises:
mode information, indicating a transmission mode of the RLC entity for sending the target data; and
wherein the transmission mode comprises at least one of: a transparent transmission mode (TM), an unacknowledged mode (UM) or an acknowledged mode (AM).

5. The method according to claim 1, wherein the first attribute information comprises one or more of the following:
importance level;
service type;
quality of service (QOS) flow identifier;
sub-QoS flow identifier; or
priority.

6. The method according to claim 1, wherein the method further comprises:
obtaining given information; wherein the given information is used to update the RLC entity for sending the target data.

7. The method according to claim 6, wherein the given information comprises at least one of the following:
second configuration information, wherein the second configuration information is used to reconfigure the RLC entity for sending the target data; or
activation information, wherein the activation information is used to update the RLC entity for sending the target data by at least one of activating an inactivated RLC entity or deactivating an activated RLC entity.

8. The method according to claim 6, wherein the method further comprises:
in response to the RLC entity for sending the target data being changed from a first RLC entity to a second RLC entity;
executing a given function of the target data,
wherein the second RLC entity comprises at least one of an RLC entity that has been established or an RLC entity that is to be established.

9. (canceled)

10. The method according to claim 8, wherein the executing the given function of the target data comprises:
performing a given operation corresponding to a transmission mode of the second RLC entity;
or,
enabling a packet data convergence protocol (PDCP)data recovery function.

11. The method according to claim 10, wherein performing the given operation corresponding to the transmission mode of the second RLC entity comprises:
in response to the transmission mode of the second RLC entity being AM, determining to send a first PDCP data unit and a second PDCP data unit to the second RLC entity;
or,
in response to a transmission mode of the second RLC entity being TM or UM, determining to send a second PDCP data unit to the second RLC entity;
wherein the first PDCP data unit comprises: a PDCP data unit that has been sent to the first RLC entity and for which feedback data is not received; and the second PDCP data unit comprises: a PDCP data unit that has not been sent to the first RLC entity, or
wherein the enabling of the PDCP data recovery function comprises:
after enabling the PDCP data recovery function, sending a first PDCP data unit and a second PDCP data unit to the second RLC entity; wherein, the first PDCP data unit comprises: a PDCP data unit that has been sent to the first RLC entity and for which feedback data is not received; the second PDCP data unit comprises: a PDCP data unit that has not been sent to the first RLC entity.

12-13. (canceled)

14. An information processing method, wherein the method is performed by an access device, the method comprising:
sending first configuration information to a user equipment (UE); wherein the first configuration information comprises:
identification information, indicating a radio link control (RLC) entity for sending target data; and
second attribute information, indicating an attribute of data that can be transmitted by the RLC entity for sending the target data.

15. The method according to claim 14, wherein the first configuration information further comprises:
mode information, indicating a transmission mode of the RLC entity for sending the target data; and
wherein the transmission mode comprises at least one of: a transparent transmission mode (TM), an unacknowledged mode (UM) or an acknowledged mode (AM).

16. The method according to claim 14, wherein the first attribute information comprises one or more of the following:
importance level;
service type;
quality of service (QoS) flow identifier;
sub-QoS flow identifier; or
priority.

17. The method according to claim 14, wherein the method further comprises:
sending second configuration information, wherein the second configuration information is used to reconfigure the RLC entity for sending the target data.

18. The method according to claim 14, wherein the method further comprises:
sending activation information, wherein the activation information is used to update the RLC entity for sending the target data by at least one of activating an inactivated RLC entity or deactivating an activated RLC entity, and
wherein the sending of activation information comprises:
sending a medium access control (MAC) control element (CE) carrying the activation information, and
wherein the activation information comprises at least one of: an activation indication, used to activate at least one inactivated RLC entity configured by the first configuration information; or a deactivation indication, used to deactivate at least one activated RLC entity configured by the first configuration information.

19-20. (canceled)

21. An information processing method, wherein the method is performed by a user equipment (UE), the method comprising:
receiving first configuration information sent by an access device; wherein the first configuration information comprises:
identification information, indicating an RLC entity for sending target data; and
second attribute information, indicating an attribute of data that can be transmitted by the RLC entity for sending the target data.

22. The method according to claim 21, wherein the first configuration information further comprises:
mode information, indicating a transmission mode of the RLC entity for sending the target data; and
wherein the transmission mode comprises at least one of: a transparent transmission mode (TM), an unacknowledged mode (UM) or an acknowledged mode (AM).

23-28. (canceled)

29. A communication device comprising a processor, a transceiver, a memory, and an executable program stored in the memory and capable of being run by the processor, wherein when the processor executes the executable program, the method according to claim 1 implemented.

30. (canceled)

31. A communication device comprising a processor, a transceiver, a memory, and an executable program stored in the memory and capable of being run by the processor, wherein when the processor executes the executable program, the method according to claim 14 is implemented.

32. A communication device comprising a processor, a transceiver, a memory, and an executable program stored in the memory and capable of being run by the processor, wherein when the processor executes the executable program, the method according to claim 21 is implemented.
